(19) United States
(12) Patent Application Publication
(10) Pub. No.: US 2024/0347962 A1
(43) Pub. Date: Oct. 17, 2024

(54) CONNECTOR, SYSTEM AND METHOD OF ASSEMBLING CONNECTOR

(71) Applicant: SUMITOMO WIRING SYSTEMS, LTD., Mie (JP)

(72) Inventor: Junpei KAWAHARA, Mie (JP)

(21) Appl. No.: 18/617,076

(22) Filed: Mar. 26, 2024

(30) Foreign Application Priority Data
Apr. 14, 2023 (JP) 2023-066415

(51) Int. Cl. H01R 13/506; H01R 13/424; H01R 43/20

(52) U.S. Cl. CPC H01R 13/506; H01R 13/424; H01R 43/20

(57) ABSTRACT

A connector includes a first housing including a plurality of first cavities extending in a front-rear direction and a first surface, first terminal fittings to be accommodated into the first cavities, a second housing including a plurality of second cavities extending in the front-rear direction and a second surface, second terminal fittings to be accommodated into the second cavities, and a hinge portion linking the first housing and the second housing such that the first housing and the second housing are displaceable to an open position OP where the first surface and the second surface are arranged in a lateral direction and a closed position CP where the first surface and the second surface are facing each other in the lateral direction. The plurality of first cavities and the plurality of second cavities are respectively arranged side by side in the lateral direction at the open position OP.

### CROSS-REFERENCE TO RELATED APPLICATIONS

This application is based on and claims priority from Japanese Patent Application No. 2023-066415, filed on Apr. 14, 2023, with the Japan Patent Office, the disclosure of which is incorporated herein in its entirety by reference.

### TECHNICAL FIELD

The present disclosure relates to a connector, a system and a method of assembling the connector.

### BACKGROUND

A connector disclosed in Japanese Patent Laid-open Publication No. 2020-179900 is provided with terminal fittings (terminals) to be connected to end parts of a cable (communication cables) and a housing (connector housing) for accommodating the terminal fittings. The housing includes a plurality of cavities (insertion holes) extending in a front-rear direction. The respective cavities are provided side by side in a lateral direction in the housing. The terminal fittings are accommodated into the cavities of the housing. The cable is connected to the terminal fittings accommodated in the housing by crimping. Connectors disclosed in Japanese Utility Model Laid-open Publication Nos. H04-015168 and H03-020888 are known as prior art of this connector.

### SUMMARY

For example, if four cavities are provided in the housing and arranged side by side in a vertical direction as well as in the lateral direction, an operation of inserting the terminal fittings from behind is a three-dimensional operation and difficult to perform.

Accordingly, the present disclosure aims to provide a connector capable of improving workability in assembling terminal fittings and the like with a housing.

This object is solved according to the invention by the features of the independent claims. Particular embodiments of the invention are subject of the dependent claims.

According to one aspect, there is provided a connector, comprising a first housing including one or more first cavities substantially extending in a front-rear direction and a first surface substantially facing in a direction intersecting the front-rear direction; one or more first terminal fittings to be at least partly accommodated into the one or more respective first cavities; a second housing including one or more second cavities substantially extending in the front-rear direction and a second surface substantially facing in a direction intersecting the front-rear direction; one or more second terminal fittings to be at least partly accommodated into the one or more respective second cavities; and at least one hinge portion linking the first housing and the second housing such that the first housing and the second housing are displaceable to an open position where the first surface of the first housing and the second surface of the second housing substantially are arranged in a lateral direction and a closed position where the first surface of the first housing and the second surface of the second housing substantially are facing each other in the lateral direction, the one or more first cavities and the one or more second cavities being respectively substantially arranged side by side in the lateral direction at the open position.

A particular embodiment is directed to a connector with a first housing including a plurality of first cavities extending in a front-rear direction and a first surface facing in a direction intersecting the front-rear direction, first terminal fittings to be accommodated into the first cavities, a second housing including a plurality of second cavities extending in the front-rear direction and a second surface facing in a direction intersecting the front-rear direction, second terminal fittings to be accommodated into the second cavities, and a hinge portion linking the first housing and the second housing such that the first housing and the second housing are displaceable to an open position where the first surface of the first housing and the second surface of the second housing are arranged in a lateral direction and a closed position where the first surface of the first housing and the second surface of the second housing are facing each other in the lateral direction, the plurality of first cavities and the plurality of second cavities being respectively arranged side by side in the lateral direction at the open position.

The connector of the present disclosure particularly is provided with a first housing including a plurality of first cavities extending in a front-rear direction and a first surface facing in a direction intersecting the front-rear direction, first terminal fittings to be accommodated into the first cavities, a second housing including a plurality of second cavities extending in the front-rear direction and a second surface facing in a direction intersecting the front-rear direction, second terminal fittings to be accommodated into the second cavities, and a hinge portion linking the first housing and the second housing such that the first housing and the second housing are displaceable to an open position where the first surface of the first housing and the second surface of the second housing are arranged in a lateral direction and a closed position where the first surface of the first housing and the second surface of the second housing are facing each other in the lateral direction, the plurality of first cavities and the plurality of second cavities being respectively arranged side by side in the lateral direction at the open position.

Accordingly, an operation of inserting the first and second terminal fittings into the respective first cavities and the respective second cavities arranged in the lateral direction and further crimping the first and second terminal fittings to a cable can be performed with the first housing and the second housing set at the open position. Thereafter, by setting the first housing and the second housing at the closed position, the respective first cavities and the respective second cavities can be arranged in the lateral direction and the vertical direction and, simultaneously, the first terminal fittings and the second terminal fittings can be arranged in the lateral direction and the vertical direction. The configuration of (1) above is advantageous in terms of workability since the terminal fittings and the like can be two-dimensionally assembled with the housings. Further, since the first housing and the second housing are linked via the hinge portion, the number of components is not increased.

Particularly, the first housing and the second housing include at least one cable accommodation space for at least partly accommodating an end part of a cable connected to the first terminal fittings and the second terminal fittings inside and/or a cable pull-out opening open to substantially communicate with the cable accommodation space at the closed position, wherein the cable can be pulled out through the cable pull-out opening.

Further particularly, at least one of the first housing and the second housing includes a wall portion for restricting a direction of the cable accommodated in the cable accommodation space toward the cable pull-out opening at the closed position.

Further particularly, the first housing and the second housing include a cable accommodation space for accommodating an end part of a cable connected to the first terminal fittings and the second terminal fittings inside and a cable pull-out opening open to communicate with the cable accommodation space at the closed position, the cable being pulled out through the cable pull-out opening, and at least one of the first housing and the second housing includes a wall portion for restricting a direction of the cable accommodated in the cable accommodation space toward the cable pull-out opening at the closed position.

Accordingly, the end part of the cable accommodated in the cable accommodation space can be bent and the cable can be pulled out through the cable pull-out opening.

Further particularly, the hinge portion is provided on a laterally central side between the first housing and the second housing.

Further particularly, the wall portion is provided on rear end parts of the first housing and the second housing.

Further particularly, the cable pull-out opening is located behind the hinge portion and in front of the wall portion in the first housing and the second housing at the closed position.

Further particularly, the hinge portion is provided on a laterally central side between the first housing and the second housing, the wall portion is provided on rear end parts of the first housing and the second housing, and the cable pull-out opening is located behind the hinge portion and in front of the wall portion in the first housing and the second housing at the closed position.

Accordingly, the cable having a bending direction restricted by the wall portion can be pulled out through the cable pull-out opening by setting the first housing and the second housing at the open position, bending the end part of the cable arranged in the cable accommodation space toward the cable pull-out opening in that state and subsequently setting the first housing and the second housing at the closed position. In this way, an operation of bending the cable and an operation of displacing the first housing and the second housing from the open position to the closed position can be continuously performed.

Further particularly, the first housing and the second housing include a locking projection lockable to the cable at the closed position on an edge part of the cable pull-out opening.

Accordingly, it is possible to easily realize a structure for suppressing a movement of the cable by setting the first housing and the second housing at the closed position.

According to another aspect, there is provided a system comprising a connector according to the above aspect or a particular embodiment thereof and a frame body connected to the connector via one or more supporting portions, which maintains the first housing and the second housing the connector at the open position.

According to another aspect, there is further provided a method of assembling a connector, comprising the following steps: providing a connector according to the above aspect or a particular embodiment thereof; positioning the first housing and the second housing of the connector at the open position; at least partly accommodating one or more first terminal fittings into the one or more respective first cavities; at least partly accommodating one or more second terminal fittings into the one or more respective second cavities; and transitioning the first housing and the second housing of the connector to the closed position.

According to a particular embodiment, the method further comprises crimping the terminal fittings to a cable in order to mechanically and/or electrically connect them with each other while the first housing and the second housing of the connector are positioned at the open position.

According to the present disclosure, it is possible to provide a connector, system and method capable of improving workability in assembling terminal fittings and the like with a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of one embodiment.

FIG. 2 is a perspective view of the connector of the embodiment when viewed from a direction different from that in FIG. 1.

FIG. 3 is a perspective view of a terminal fitting in the connector of the embodiment.

FIG. 4 is a perspective view of a first housing in the connector of the embodiment.

FIG. 5 is a perspective view of a second housing in the connector of the embodiment.

FIG. 6 is a perspective view of a housing supported on a frame body in the connector of the embodiment.

FIG. 7 is a perspective view showing a state where the terminal fittings are accommodated in the housing supported on the frame body in the connector of the embodiment.

FIG. 8 is a perspective view showing a state where a front end part of a cable is inserted in the housing and core wires of the cable are respectively disposed in barrel portions of the terminal fittings in the connector of the embodiment.

FIG. 9 is a front view of the first and second housings at an open position in the connector of the embodiment.

FIG. 10 is a perspective view showing a state where the front end part of the cable is being bent and the first and second housings are being moved from the open position to a closed position in the connector of the embodiment.

FIG. 11 is a transverse section of the connector of the embodiment cut in a part where the cable is pulled out through a cable pull-out opening.

FIG. 12 is an enlarged bottom view of the part where the cable is pulled out through the cable pull-out opening in the connector of the embodiment when viewed from below.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Embodiment

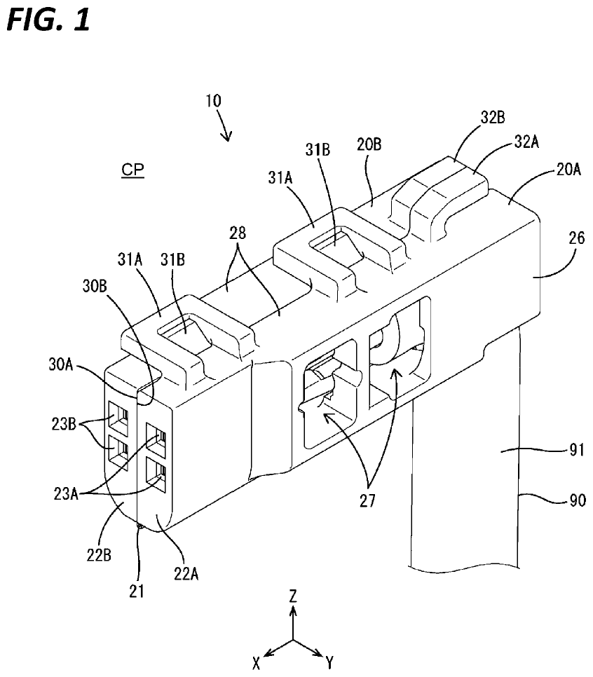

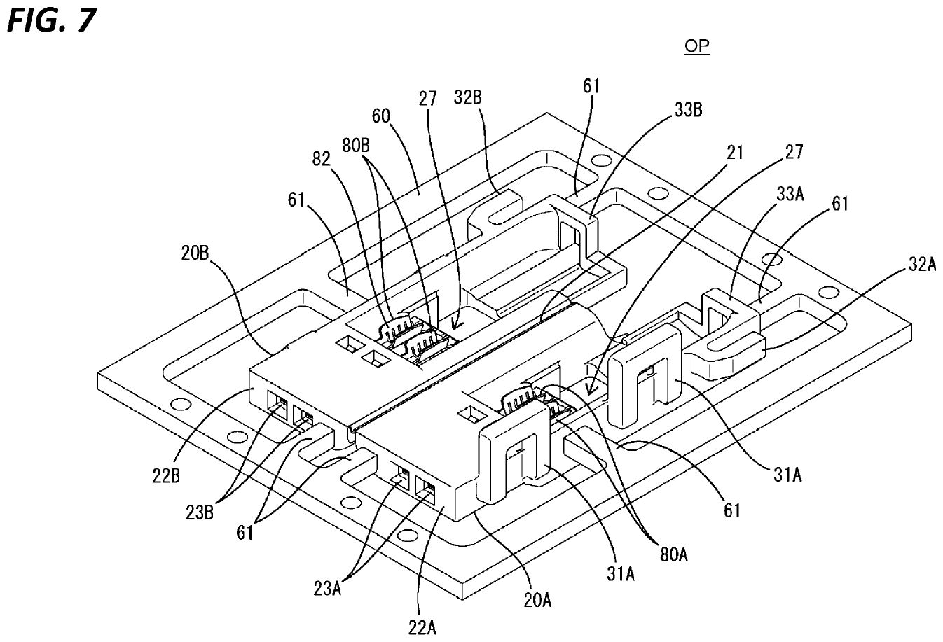

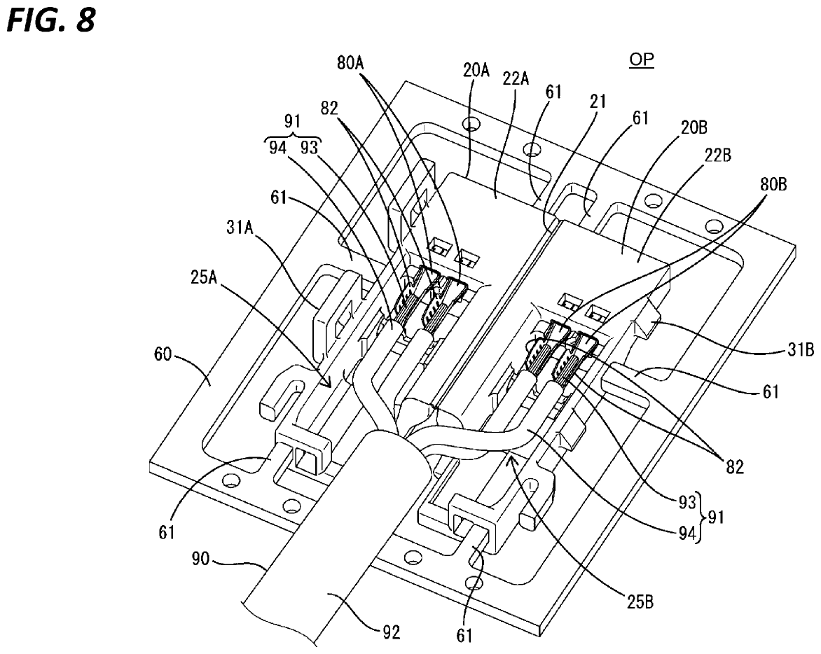

A connector 10 of one embodiment of the present disclosure is a connector particularly suitable for high-speed communication of an automotive vehicle and provided with a housing 20A, 20B and a plurality of terminal fittings 80A, 80B to be at least partly accommodated into the housing 20A, 20B. As shown in FIG. 1, a housing is constituted by or comprises a first housing 20A and a second housing 20B. As shown in FIGS. 7 and 8, the one or more terminal fittings 80A, 80B are to be respectively at least partly accommodated in the first housing 20A and the second housing 20B. In this specification, the one or more terminal fittings to be accommodated into the first housing 20A are referred to as first terminal fitting(s) 80A, and the one or more terminal fittings to be accommodated into the second housing 20B are referred to as second terminal fitting(s) 80B.

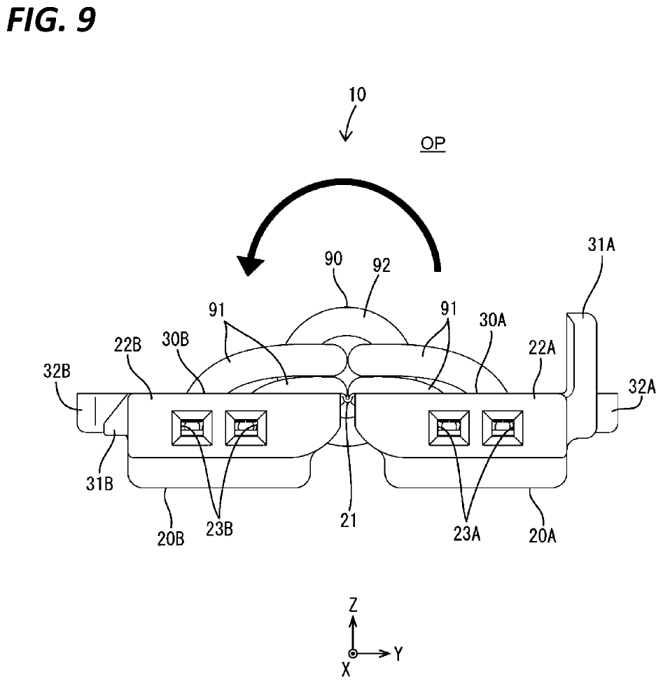

The housing 20A, 20B is connectable to an unillustrated mating connector. Note that, in the following description, a surface side of the housing 20A, 20B to be connected to a mating housing is referred to as a front side concerning a front-rear direction. A vertical direction is based on a vertical direction of FIG. 9 when the first housing 20A and the second housing 20B are at an open position OP to be described later, and based on a vertical direction of FIG. 1 when the first housing 20A and the second housing 20B are at a closed position CP to be described later. In FIGS. 1, 4, 5 and 9, the front side is represented by X, a right side is represented by Y and an upper side is represented by Z. These direction references do not necessarily coincide with direction references in a state where the connector 10 is installed in an unillustrated vehicle or the like.

### Terminal Fittings 80A, 80B and Cable 90

The one or more first terminal fittings 80A and the one or more second terminal fittings 80B particularly are formed to have the similar or substantially same shape and/or the similar or substantially same size.

As shown in FIGS. 7 and 8, one or more, e.g. two first terminal fittings 80A at least partly are accommodated into the first housing 20A and/or one or more, e.g. two second terminal fittings 80B at least partly are accommodated into the second housing 20B.

The terminal fitting 80A, 80B is formed, such as by folding, bending and/or embossing an electrically conductive (particularly metal) plate material.

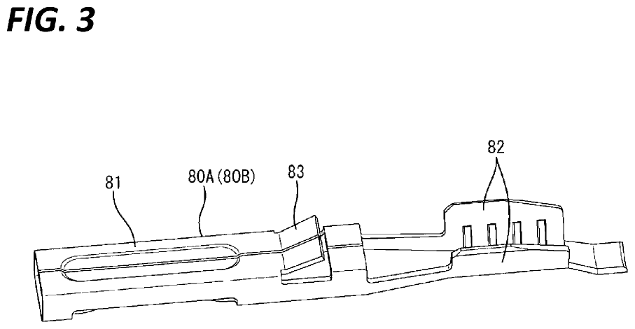

As shown in FIG. 3, the terminal fitting 80A, 80B includes a connecting portion 81 (particularly substantially in the form of a polygonal or rectangular tube) and at least one barrel portion 82 connected to or behind or adjacent the connecting portion 81. An unillustrated mating terminal fitting provided in the mating connector is to be at least partly inserted and electrically connected to the connecting portion 81.

Further, the connecting portion 81 particularly is formed with at least one lance portion 83. The lance portion 83 particularly substantially is a projecting piece formed by cutting a part of the lateral or upper wall of the connecting portion 81 and/or raising the cut part outward, and/or is resiliently deformable in a direction intersecting a longitudinal direction (e.g. substantially in the vertical direction).

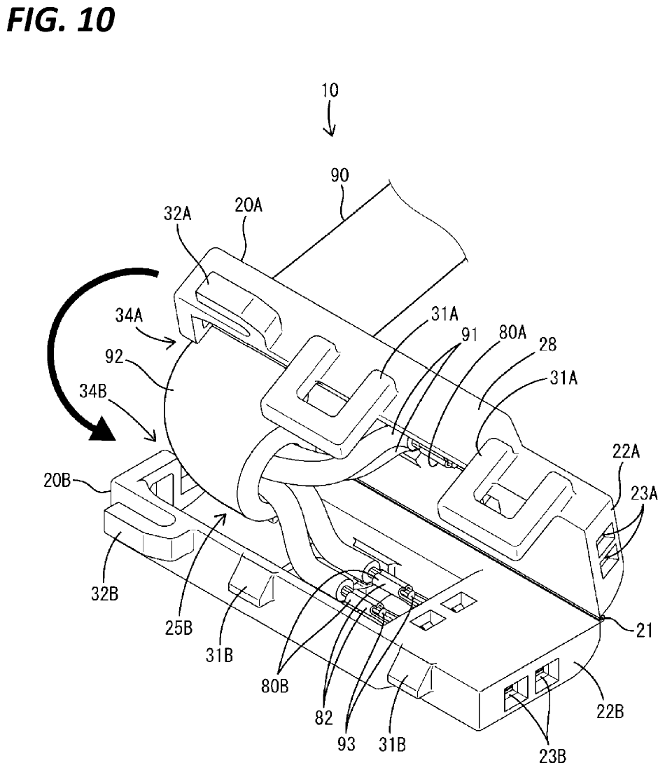

As shown in FIG. 10, the barrel portion 82 is to be crimped or bent and electrically connected to a later-described cable 90, particularly a core wire 93 of the cable 90.

As shown in FIG. 8, the cable 90 is configured such that the one or more outer peripheries of one or more (e.g. four) coated wires 91 are collectively surrounded by at least one sheath 92. For example, out of the exemplary four coated wires 91, two coated wires 91 are used as power supply wires, and the other two coated wires 91 are used as signal wires. The respective coated wires 91 particularly substantially are twisted to configure a twisted pair cable.

The coated wire 91 particularly substantially is composed of or comprises the electrically conductive core wire 93 and an insulation coating 94 e.g. made of synthetic resin and/or at least partly surrounding the outer periphery of the core wire 93.

Specifically, the sheath 92 is made of synthetic resin, has a tubular (pipe-like) shape and/or has an insulating property and flexibility. A front end part of the sheath 92 particularly is processed, such as by stripping, to expose one or more front end parts of the one or more respective coated wires 91.

Specifically, the front end part(s) of the respective coated wire(s) 91 is/are untwisted and/or arranged apart from each other in the lateral direction at the open position OP (state of FIG. 8) to be described later.

Further specifically, in two coated wires 91 located on one lateral side, the core wires 93 exposed by removing the insulation coatings 94 in the front end parts are connected to the first terminal fittings 80A. In two coated wires 91 located on the other lateral side, the core wires 93 exposed by removing the insulation coatings 94 in the front end parts are connected to the second terminal fittings 80B.

### Housing 20A, 20B

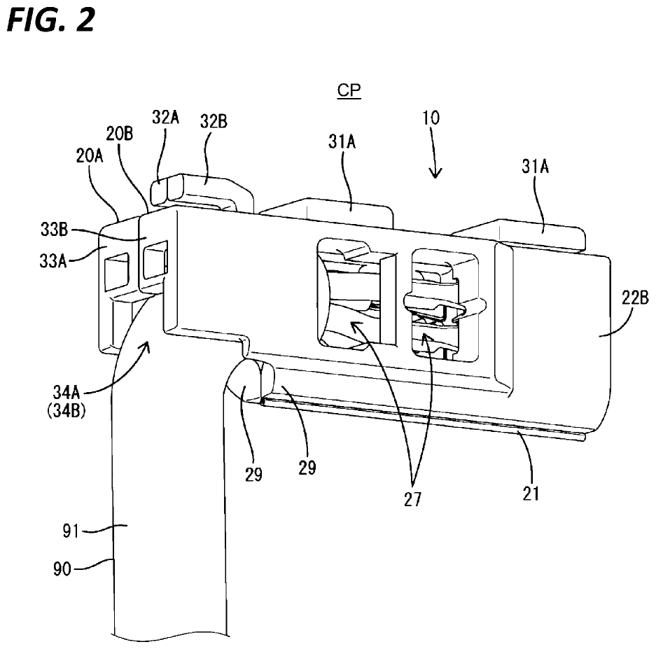

As shown in FIGS. 1 and 2, the housing 20A, 20B is composed of or comprises the first housing 20A, the second housing 20B and at least one hinge portion 21 at least partly linking the first housing 20A and the second housing 20B.

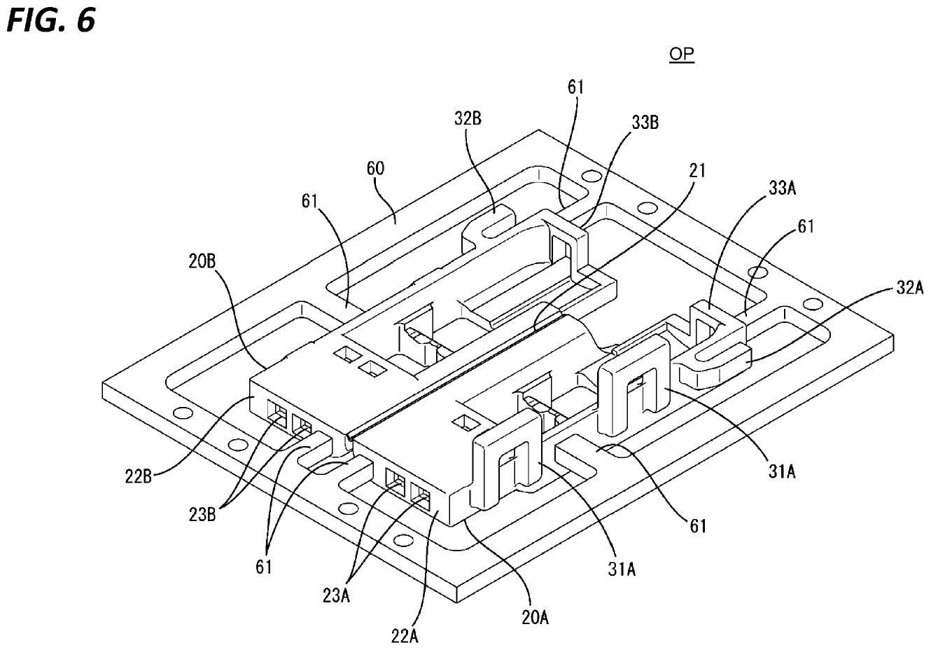

The first housing 20A and the second housing 20B particularly substantially are openably and closably displaced to the open position OP (see FIGS. 6 to 9) and the closed position CP (see FIGS. 1, 2, 11 and 12) via the hinge portion 21. Hereinafter, unless otherwise specified, direction references are based on the state where the first housing 20A and the second housing 20B are at the open position OP.

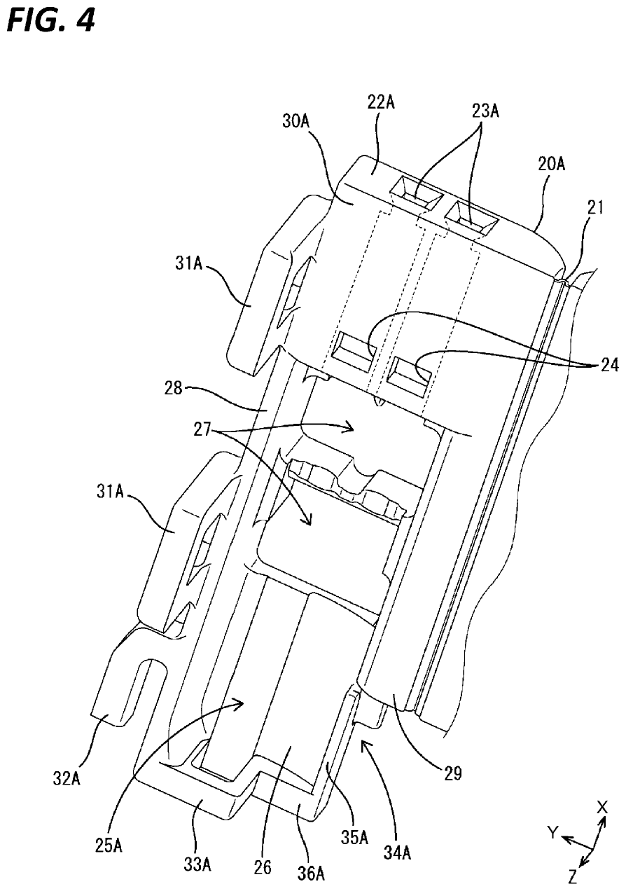

As shown in FIG. 4, the first housing 20A particularly substantially has a rectangular or polygonal shape long in the front-rear direction in a plan view and/or includes a (particularly substantially flat) first terminal accommodating portion 22A on or near a front end side.

The first terminal accommodating portion 22A particularly includes one or more, particularly a plurality of first cavities 23A capable of at least partly accommodating (particularly the connecting portion(s) 81 of) the first terminal fitting(s) 80A.

Specifically, two first cavities 23A substantially penetrate through the first terminal accommodating portion 22A in the front-rear direction and/or substantially are arranged side by side in the lateral direction.

The first terminal accommodating portion 22A particularly substantially has a flat first surface 30A facing upward on an upper wall defining the respective first cavities 23A.

The lateral or upper wall of each first cavity 23A includes at least one locking hole 24 penetrating (e.g. substantially in the vertical direction) and having an upper or distal end open in the first surface 30A and/or a lower or distal end communicating with the first cavity 23A.

The first terminal fitting 80A at least partly is inserted or insertable into the first cavity 23A from an insertion direction (e.g. substantially from behind) and/or retained in the first cavity 23A by at least partly inserting and locking the lance portion 83 into the locking hole 24.

The first housing 20A includes a first cable accommodation space 25A capable of at least partly accommodating (particularly the front end part of) the cable 90 adjacent or behind the first terminal accommodating portion 22A.

The first housing 20A includes one or more, particularly a pair of (front and rear) through holes 27 penetrating through a lateral or bottom wall portion 26 defining the lateral or lower surface of the first cable accommodation space 25A.

As shown in FIG. 8, when the connecting portion 81 of the first terminal fitting 80A at least partly is accommodated into the first cavity 23A, the barrel portion 82 of the first terminal fitting 80A particularly substantially is arranged in the first cable accommodation space 25A.

As shown in FIG. 4, both lateral (left and right) end parts of the first housing 20A are respectively configured as lateral (left and right) side wall portions 28, 29. Front end parts of the respective side wall portions 28, 29 particularly substantially constitute lateral (left and right) side walls of the first terminal accommodating portion 22A, and/or parts thereof behind the first terminal accommodating portion 22A particularly substantially define both lateral (left and right) side surfaces of the first cable accommodation space 25A.

One or more, particularly a pair of first lock portions 31A and/or at least one first hooking portion 32A are formed to project on the side wall portion 28 arranged on a lateral outer end part (right end part), out of the respective side wall portions 28, 29.

Specifically, the first hooking portion 32A substantially has a hook shape particularly substantially protruding laterally outward from (particularly the upper or distal end edge of) the side wall portion 28 and/or further projecting rearward.

The one or more respective first lock portions 31A are provided (particularly at an interval in the front-rear direction) in a part on the side of the first terminal accommodating portion 22A and/or a part on the side of the first cable accommodation space 25A on (particularly the upper or distal end edge of) the side wall portion 28.

Each first lock portion 31A particularly substantially is gate-shaped in a side view, and/or projects upward from the upper end edge of the side wall portion 28.

The first housing 20A includes a first wall portion 33A rising from (particularly a lateral outer part of the rear end edge of) the bottom wall portion 26.

Specifically, the first wall portion 33A and (particularly the front end edge of) the side wall portion 28 substantially are connected at a right angle to each other.

The first housing 20A particularly includes at least one first cable pull-out opening 34A, through which the cable 90 can be pulled out, particularly substantially in a lateral inner and rear end part (left end part and end part on the side of the hinge portion 21). The first cable pull-out opening 34A particularly substantially is defined by the rear end edge of the side wall portion 29 arranged on a lateral inner side, the lateral inner end edge of the bottom wall portion 26 and the lateral inner end edge of the first wall portion 33A.

Specifically, the rear end edge of the side wall portion 29 substantially is curved in a side view and/or arranged in front of the first wall portion 33A. The lateral inner end edge of the bottom wall portion 26 particularly substantially extends straight in the front-rear direction and is arranged laterally outward of the side wall portion 29.

The first housing 20A particularly includes at least one first locking projection 35A particularly substantially in the form of a rib extending along the lateral inner end edge of the bottom wall portion 26 and/or rising upward.

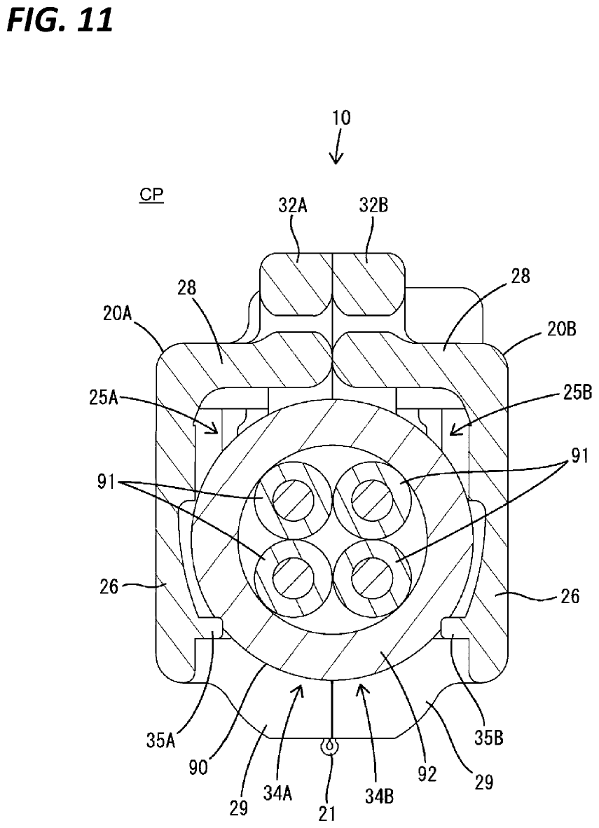

As shown in FIG. 11, the first locking projection 35A particularly bites into (or engages) and/or is lockable to the outer peripheral surface of the sheath 92 of the cable 90 at the closed position CP.

As shown in FIG. 4, the first housing 20A includes, particularly substantially on a rear end edge, at least one first rib 36A substantially extending along the lateral direction and/or linking the lateral inner end edge of the first wall portion 33A and the rear end edge of the first locking projection 35A. The first rib 36A particularly substantially is continuous with the first locking projection 35A (particularly at the substantially same height) and/or is formed to be shorter in height than the first wall portion 33A.

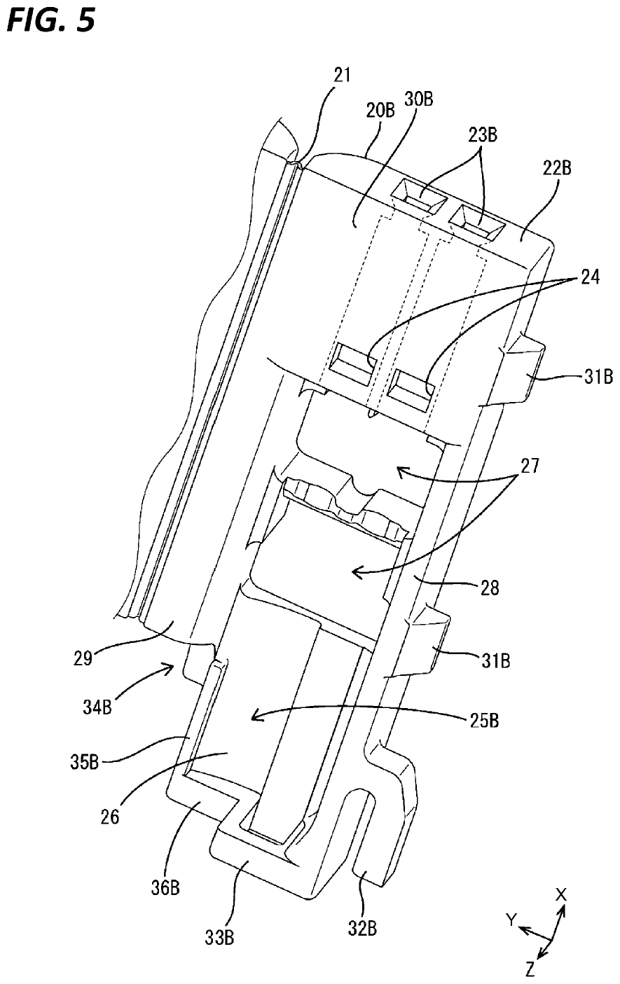

As shown in FIGS. 5 and 8, the second housing 20B includes one or more second lock portions 31B particularly substantially shaped differently from the first lock portions 31A in parts corresponding to the respective first lock portions 31A.

The second housing 20B particularly substantially is shaped similarly to the first housing 20A except parts corresponding to the respective second lock portions 31B. That is, the second housing 20B includes, as shown in FIG. 5, at least one second terminal accommodating portion 22B, one or more second cavities 23B, a second surface 30B, at least one second cable accommodation space 25B, at least one second cable pull-out opening 34B, at least one second hooking portion 32B, a second wall portion 33B, at least one second locking projection 35B and/or at least one second rib 36B, which particularly are respectively shaped to substantially correspond to the at least one first terminal accommodating portion 22A, the one or more first cavities 23A, the first surface 30A, the at least one first cable accommodation space 25A, the at least one first cable pull-out opening 34A, the at least one first hooking portion 32A, the first wall portion 33A, the at least one first locking projection 35A and/or the at least one first rib 36A at corresponding positions.

The second surface 30B particularly substantially is the upper or distal surface of an upper or distal wall defining the one or more respective second cavities 23B in the second terminal accommodating portion 22B and/or substantially is flatly arranged while facing upward.

Specifically, the first housing 20A and the second housing 20B substantially are line-symmetrically shaped via the at least one hinge portion 21 except the respective first lock portion(s) 31A and the respective second lock portion(s) 31B.

As shown in FIG. 5, the respective one or more second lock portions 31B particularly substantially are in the form of claws projecting (particularly at an interval in the front-rear direction) on a second wall portion 28, particularly on an upper end side of the lateral outer side surface of the second wall portion 28.

As shown in FIG. 1, the respective one or more second lock portions 31B particularly are to be fit and locked inside the respective one or more first lock portions 31A at the closed position CP. By locking the respective first lock portion(s) 31A and the respective second lock portion(s) 31B to each other, a closed state of the first housing 20A and the second housing 20B at the closed position CP can be maintained.

The first and second hooking portions 32A, 32B particularly substantially are arranged side by side in the lateral direction at the closed position CP, and/or lockable to an unillustrated outer member for accommodating the housing 20A, 20B.

As shown in FIGS. 2 and 4 to 6, the hinge portion 21 is formed to extend along the front-rear direction particularly substantially in a laterally central or intermediate part between the first housing 20A and the second housing 20B (between lateral inner end parts of the respective housings).

The hinge portion 21 is flexible to be bendable at least in an opening/closing direction of the first housing 20A and the second housing 20B. The hinge portion 21 has, for example, a U-shaped cross-section and is curved downward from the upper end edges of the respective side wall portions 29 of the first housing 20A and the second housing 20B.

As shown in FIG. 9, when the first housing 20A and the second housing 20B are at the open position OP, the first and second surfaces 30A, 30B are arranged substantially side by side to be at least partly connected in the lateral direction via the hinge portion 21.

As shown in FIG. 1, when the first housing 20A and the second housing 20B are at the closed position CP, the first and second surfaces 30A, 30B are arranged to be able to substantially face and/or contact each other.

As a whole, the first housing 20A and the second housing 20B particularly substantially are arranged in a horizontal posture to be flat in the lateral direction at the open position OP, and/or arranged in a vertical posture to at least partly overlap in the lateral direction at the closed position CP.

By rotating or pivoting either one of the first housing 20A and the second housing 20B e.g. substantially by 180° via the at least one hinge portion 21, the one housing can reach the closed position CP to overlap the other housing (see arrows in FIGS. 9 and 10).

Note that the first housing 20A and the second housing 20B particularly can be maintained in a state open by 180° at the open position OP by being supported on a frame body 60 (see FIG. 6) to be described later.

As shown in FIGS. 1 and 11, the respective bottom wall portions 26 of the first housing 20A and the second housing 20B are arranged with wall surfaces substantially facing in the lateral direction at the closed position CP. In short, the respective bottom wall portions 26 constitute or form part of left and right side wall parts of the housing 20A, 20B at the closed position CP.

Specifically, the respective side wall portions 28 of the first housing 20A and the second housing 20B constitute an upper wall part of the housing 20A, 20B at the closed position CP, and/or are arranged to at least partly butt against each other particularly in a laterally central or intermediate part of the connector 10.

As shown in FIG. 2, the respective one or more side wall portions 29 of the first housing 20A and the second housing 20B particularly constitute a lower wall part of the housing 20A, 20B at the closed position CP, and/or particularly are arranged to be substantially curved downward via the hinge portion 21.

As shown in FIG. 1, the first and second terminal accommodating portions 22A, 22B particularly substantially are arranged side by side in the lateral direction with the facing first and second surfaces 30A, 30B (upper surfaces at the open position) at least partly held in contact at the closed position CP.

As shown in FIG. 11, the first and second cable accommodation spaces 25A, 25B particularly substantially communicate with each other at the closed position CP and/or substantially configure a cable accommodation space 25A, 25B, in which the front end part of the sheath 92 of the cable 90 at least partly is inserted or insertable particularly in a bent state.

The first and second cable pull-out openings 34A, 34B particularly substantially communicate with each other at the closed position CP, also communicate with the cable accommodation space 25A, 25B in the vertical direction and/or configure a cable pull-out opening 34A, 34B, through which the sheath 92 of the cable 90 can be pulled out (particularly substantially downwardly) of the housing 20A, 20B.

The cable pull-out opening 34A, 34B particularly substantially is open in the lower or lateral surface of the housing 20A, 20B.

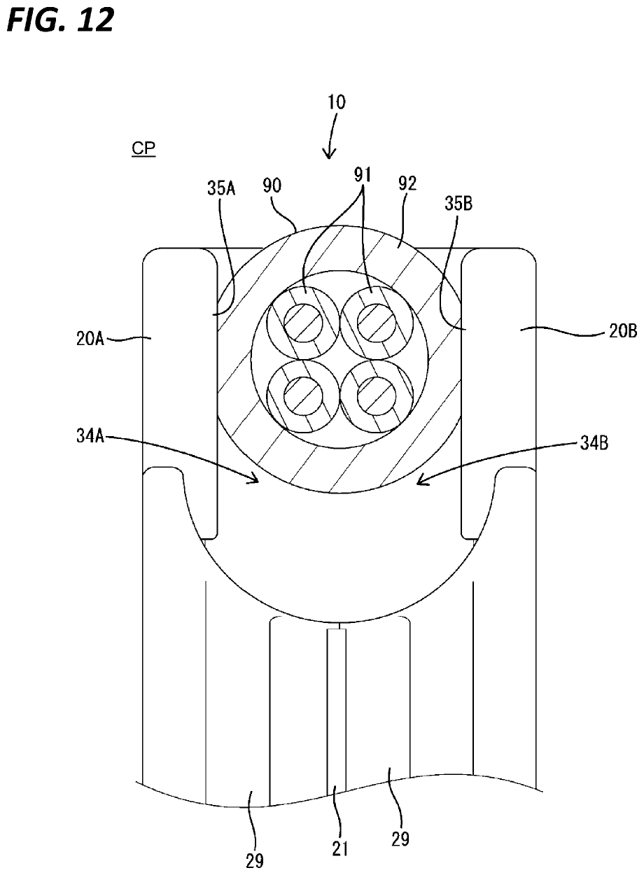

As shown in FIG. 12, the rear end edges of the respective side wall portions 29 of the first housing 20A and the second housing 20B particularly substantially form a semicircular arc shape in a bottom view via the at least one hinge portion 21 as a whole at the closed position CP, and/or particularly substantially are arranged at a distance from the outer peripheral surface of the sheath 92 of the cable 90.

The first and second wall portions 33A, 33B particularly substantially are arranged apart on both sides in the lateral direction across the cable accommodation space 25A, 25B at the open position OP (see FIG. 6), and/or particularly substantially arranged at least partly in contact with each other in the lateral direction at the closed position (see FIG. 2).

The first and second wall portions 33A, 33B particularly substantially constitute a wall portion 33A, 33B for specifying a direction of the cable 90 by contacting (particularly the front end part of) the sheath 92 of the cable 90 in the bent state at the closed position CP particularly substantially from behind.

As shown in FIGS. 11 and 12, the first and second locking projections 35A, 35B particularly substantially are arranged apart on both sides in the lateral direction across the cable pull-out opening 34A, 34B at the closed position CP and/or constitute or form part of one or more locking projections 35A, 35B for contacting the outer peripheral surface of the sheath 92 of the cable 90 particularly substantially from both left and right sides.

The first and second cavities 23A, 23B particularly constitute cavities 23A, 23B particularly substantially arranged side by side in a row in the lateral direction at the open position OP (see FIG. 9) and/or particularly substantially arranged side by side in the lateral direction and the vertical direction at the closed position CP (see FIG. 1).

### Manufacturing Method and Functions of Connector 10

As shown in FIG. 6, the housing 20A, 20B particularly is supplied in a state where the first housing 20A and the second housing 20B at the open position OP are supported inside or on the frame body 60 (runner) (particularly substantially having a rectangular shape in a plan view) via one or more supporting portions 61 (gates).

The frame body 60 is a part of an unillustrated carrier, which is not entirely shown. The carrier particularly is made of the synthetic resin material (e.g. for constituting the housing 20A, 20B) and/or configured such that one or more, particularly a plurality of frame bodies 60 are (particularly successively) arranged in the lateral direction.

An unillustrated long body, which is not entirely shown, is configured by linking each housing 20A, 20B to the carrier.

Specifically, the long body is or can be dispensed from an unillustrated reel and taken up by another unillustrated reel, whereby the terminal fittings 80A, 80B can be mounted into the housing 20A, 20B arranged between the both reels (see FIG. 5 of Japanese Patent Laid-open Publication No. 2020-179900 for reference, which is incorporated herein by reference with the respective description). That is, the housing 20A, 20B particularly substantially is arranged along the lateral direction between the both reels and the first and second cavities 23A, 23B are open rearward.

As shown in FIG. 7, the one or more first terminal fittings 80A and the one or more second terminal fittings 80B are respectively mounted into the first housing 20A and the second housing 20B at the open position OP.

Specifically, the first and second terminal fittings 80A, 80B at least partly are respectively inserted into the first and second cavities 23A, 23B from an insertion side, e.g. from behind, and/or held retained in the first housing 20A and the second housing 20B by locking the one or more lance portions 83 into the one or more locking holes 24 although not shown in detail.

The connecting portions 81 of the first and second terminal fittings 80A, 80B particularly substantially are respectively accommodated into the first and second cavities 23A, 23B, and/or the barrel portions 82 thereof particularly substantially are arranged in the first and second cable accommodation spaces 25A, 25B.

The respective barrel portions 82 of the first and second terminal fittings 80A, 80B particularly substantially are arranged at positions facing the corresponding through holes 27.

One or more, particularly a pair of the first cavities 23A and one or more, particularly a pair of the second cavities 23B are respectively arranged (particularly substantially side by side in a row in the lateral direction) in the first housing 20A and the second housing 20B at the open position OP, and particularly are not arranged separately in the lateral direction and the vertical direction.

If cavities are arranged separately in the lateral direction and the vertical direction in a housing unlike this embodiment, terminal fittings need to be three-dimensionally mounted into the housing, which is disadvantageous in terms of workability. In contrast, since the respective terminal fittings 80A, 80B can be two-dimensionally mounted into the housing 20A, 20B in the case of this embodiment, the respective first terminal fitting(s) 80A and the respective second terminal fitting(s) 80B can be easily inserted into the respective first cavities 23A and the respective second cavities 23B by an automatic machine or while being held by hand.

Note that the terminal fittings 80A, 80B particularly are supplied to an insertion step in the form of the reel of the terminal fittings 80A, 80B and cut off.

Subsequently, (particularly the front end part of) the cable 90 at least partly is inserted into the housing 20A, 20B provided in the long body particularly dispensed from the reel as shown in FIG. 8.

Specifically, the one or more core wires 93 of the respective one or more coated wires 91 exposed in the front end part of the cable 90 at least partly are arranged in the first and second cable accommodation spaces 25A, 25B and/or respectively placed on the one or more barrel portions 82 of the one or more corresponding terminal fittings 80A, 80B.

In this state, an unillustrated crimping tool particularly is pressed against the barrel portions 82 e.g. in the vertical direction. Specifically, an unillustrated anvil of the crimping tool contacts the barrel portion(s) 82 through the through hole(s) 27 (e.g. from below) and an unillustrated crimper of the crimping tool contacts the barrel portion(s) 82 through the cable accommodation space(s) 25A, 25B (e.g. from above). Then, the barrel portions 82 are crimped or bent to the core wires 93 by displacing or lowering the crimper.

In this way, the terminal fittings 80A, 80B are electrically and/or mechanically connected to the core wires 93 of the cable 90 (see FIG. 10).

As described above, an operation of crimping the barrel portion(s) 82 of the terminal fitting(s) 80A, 80B to the core wire(s) 93 of the coated wire(s) 91 particularly is performed with the first housing 20A and the second housing 20B located at the open position OP.

Specifically, the core wires 93 of the respective coated wires 91 placed on the respective barrel portions 82 are arranged substantially side by side in a row in the lateral direction and/or are not separated in the lateral direction and the vertical direction.

If barrel portions are arranged side by side in the vertical direction unlike this embodiment, it is difficult to operate the crimping tool for the respective barrel portions. In contrast, in the case of this embodiment, the crimping tool particularly can be operated in the vertical direction without any trouble for the respective barrel portions 82 and the core wires 93 of the respective coated wires 91 particularly substantially arranged side by side in the lateral direction, and the crimping operation can be easily performed.

Further, the cable 90 particularly substantially can be crimped at once with the respective terminal fittings 80A, 80B at least partly accommodated in the respective cavities 23A, 23B, and the crimping operation needs not be performed in another step.

Subsequently, the one or more respective supporting portions 61 particularly are cut and/or the housing 20A, 20B is cut off from the frame body 60.

At this time, as shown in FIG. 9, the front end part of the cable 90 particularly substantially is arranged in the laterally central or intermediate part of the connector 10 at the open position OP. Specifically, the front end part of the cable 90 substantially is arranged over the first and second cable accommodation spaces 25A, 25B behind the hinge portion 21 at the open position OP.

In that state, as shown in FIG. 10, the front end part of the cable 90 particularly substantially is bent toward a side where the first and second cable pull-out opening(s) 34A, 34B is/are located.

Further, the first housing 20A and the second housing 20B particularly substantially are rotated or pivoted or displaced toward the closed position CP via the at least one hinge portion 21.

By particularly locking the first lock portions 31A and the second lock portions 31B to each other as shown in FIG. 1, the first housing 20A and the second housing 20B are held at the closed position CP.

As shown in FIG. 2, the first and second wall portions 33A, 33B particularly substantially are in contact with parts on both left and right sides of the outer peripheral surface curved on a rear side in the front end part of the sheath 92 of the cable 90, thereby restricting the direction of the cable 90 to a downward direction toward the cable pull-out openings 34, 34B.

As shown in FIG. 11, the first and second locking projections 35A, 35B particularly substantially are in contact with parts of the outer peripheral surface of the sheath 92 of the cable 90 arranged in the cable pull-out opening 34A, 34B while biting thereinto. In this way, the front end part of the sheath 92 of the cable 90 can be maintained in a state bent in the cable accommodation space 25A, 25B.

As described above, according to this embodiment, an operation of inserting the respective first terminal fitting(s) 80A and the respective second terminal fitting(s) 80B into the one or more respective first cavities 23A and the one or more respective second cavities 23B arranged in the lateral direction and particularly further crimping the respective first terminal fittings 80A and the respective second terminal fittings 80B to the cable 90 can be performed with the first housing 20A and the second housing 20B set at the open position OP.

Thereafter, by setting or transitioning the first housing 20A and the second housing 20B at or to the closed position OC, the one or more respective first cavities 23A and the one or more respective second cavities 23B substantially can be arranged in the vertical direction as well as in the lateral direction and, simultaneously, the one or more respective first terminal fittings 80A and the one or more respective second terminal fittings 80B substantially can be arranged in the vertical direction as well as in the lateral direction.

In the case of this embodiment, since the first and second terminal fittings 80A, 80B can be two-dimensionally inserted into the first and second cavities 23A, 23B arranged in the lateral direction and/or the crimping operation of the cable 90 can be performed, workability in assembling the terminal fittings 80A, 80B and the cable 90 with the housing 20A, 20B can be improved. Further, since the first housing 20A and the second housing 20B are linked via the one or more hinge portion 21, the number of components is not increased.

Further, in the case of this embodiment, when the first housing 20A and the second housing 20B are at the closed position CP, the wall portions 33A, 33B at least partly contact the outer peripheral surface of the sheath 92 of the cable 90 (e.g. from behind) and/or the locking projections 35A, 35B are in contact with the outer peripheral surface of the sheath 92 of the cable 90 particularly while biting thereinto. Thus, the configuration of this embodiment enables the cable 90 to be pulled out through the cable pull-out opening 34A, 34B while maintaining the bent state of the front end part of the cable 90 at least partly accommodated in the cable accommodation space 25A, 25B.

Particularly, the configuration of this embodiment enables the operation of bending the cable 90 and the operation of displacing the first housing 20 and the second housing 20B from the open position OP toward or to the closed position CP to be substantially continuously performed by a series of operations.

Further, since the one or more locking projections 35A, 35B particularly suppress a movement of the cable 90 at the closed position CP, the cable 90 can be kept positioned in the cable pull-out opening 34A, 34B.

Further, in the case of this embodiment, since the one or more respective terminal fittings 80A, 80B at least partly are insertable into the respective cavities 23A, 23B particularly without being cut off from the carrier and/or the operation of crimping the respective terminal fittings 80A, 80B to the cable 90 can be performed in that state, workability is more excellent.

Accordingly, to provide a connector capable of improving workability in assembling terminal fittings and the like with a housing, a connector 10 is provided with a first housing 20A including one or more, particularly a plurality of first cavities 23A substantially extending in a front-rear direction and a first surface 30A, one or more first terminal fittings 80A to be at least partly accommodated into the one or more first cavities 23A, a second housing 20B including one or more, particularly a plurality of second cavities 23B substantially extending in the front-rear direction and a second surface 30B, one or more second terminal fittings 80B to be at least partly accommodated into the one or more second cavities 23B, and at least one hinge portion 21 linking or connecting the first housing 20A and the second housing 20B such that the first housing and the second housing are displaceable between an open position OP where the first surface 30A and the second surface 30B substantially are arranged in a lateral direction and a closed position CP where the first surface 30A and the second surface 30B substantially are facing each other in the lateral direction. The one or more, particularly the plurality of first cavities 23A and the one or more, particularly the plurality of second cavities 23B are respectively arranged substantially side by side in the lateral direction at the open position OP.

### Other Embodiments of Present Disclosure

The embodiment disclosed this time should be considered illustrative in all aspects, rather than restrictive.

In the case of the above embodiment, the first and second terminal fittings are formed to have the substantially same shape and/or the substantially same size. In contrast, according to another embodiment, first and second terminal fittings may have mutually different shapes and/or may have mutually different sizes.

In the case of the above embodiment, two first cavities and two second cavities are respectively provided laterally substantially side by side in the first housing and the second housing. In contrast, according to another embodiment, one first cavity and one second cavity or three or more first cavities and three or more second cavities may be respectively provided in a first housing and a second housing.

In the case of the above embodiment, the wall portion particularly substantially is constituted by the first wall portion provided on the first housing and the second wall portion provided on the second housing. In contrast, according to another embodiment, a wall portion may be constituted by either one of the first and second wall portions.

In the case of the above embodiment, the cable particularly is constituted or configured as a cable for high-speed communication. In contrast, according to another embodiment, a cable may be an ordinary cable not used for high-speed communication. For example, a cable may be constituted only by or comprise one or more, particularly a plurality of coated wires e.g. not twisted each other.

In the case of the above embodiment, the first housing and the second housing particularly substantially are maintained in the state at the open position by being supported on the frame body. In contrast, according to another embodiment, a first housing and a second housing may be maintained or positioned at an open position, for example, by being placed on a support table or the like without via a frame body or may be held by a clamp-like structure clamping the first housing and the second housing.

In the case of the above embodiment, the first and second surfaces particularly substantially are formed on the walls defining the cavities. In contrast, according to another embodiment, first and second surfaces may be configured as an opening surface in a part penetrating through a part or the entirety of a wall of a housing.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector (10), comprising:
a first housing (20A) including one or more first cavities (23A) substantially extending in a front-rear direction and a first surface (30A) substantially facing in a direction intersecting the front-rear direction;
one or more first terminal fittings (80A) to be at least partly accommodated into the one or more respective first cavities (23A);
a second housing (20B) including one or more second cavities (23B) substantially extending in the front-rear direction and a second surface (30B) substantially facing in a direction intersecting the front-rear direction;
one or more second terminal fittings (80B) to be at least partly accommodated into the one or more respective second cavities (23B); and
at least one hinge portion (21) linking the first housing (20A) and the second housing (20B) such that the first housing (20A) and the second housing (20B) are displaceable to an open position (OP) where the first surface (30A) of the first housing (20A) and the second surface (30B) of the second housing (20B) substantially are arranged in a lateral direction and a closed position (CP) where the first surface (30A) of the first housing (20A) and the second surface (30B) of the second housing (20B) substantially are facing each other in the lateral direction,
the one or more first cavities (23A) and the one or more second cavities (23B) being respectively substantially arranged side by side in the lateral direction at the open position (OP).

2. The connector according to claim 1, wherein:
the first housing (20A) and the second housing (20B) include at least one cable accommodation space (25A; 25B) for at least partly accommodating an end part of a cable connected to the first terminal fittings (80A) and the second terminal fittings (80B) inside and/or a cable pull-out opening (34A; 34B) open to substantially communicate with the cable accommodation space (25A; 25B) at the closed position (CP), wherein the cable (90) can be pulled out through the cable pull-out opening (34A; 34B).

3. The connector according to claim 2, wherein at least one of the first housing (20A) and the second housing (20B) includes a wall portion (33A; 33B) for restricting a direction of the cable (90) accommodated in the cable accommodation space (25A; 25B) toward the cable pull-out opening (34A; 34B) at the closed position (CP).

4. The connector according to claim 3, wherein the hinge portion (21) is provided on a laterally central side between the first housing (20A) and the second housing (20B).

5. The connector according to claim 4, wherein the wall portion (33A; 33B) is provided on rear end parts of the first housing (20A) and the second housing (20B).

6. The connector according to claim 5, wherein the cable pull-out opening (34A; 34B) is located behind the hinge portion (21) and in front of the wall portion (33A; 33B) in the first housing (20A) and the second housing (20B) at the closed position (CP).

7. The connector according to claim 2, wherein the first housing (20A) and the second housing (20B) include at least one locking projection (35A; 35B) lockable to the cable (90) at the closed position (CP) on an edge part of the cable pull-out opening (34A; 34B).

8. A system comprising the connector (10) according to claim 1 and a frame body (60) connected to the connector (10) via one or more supporting portions (61), which maintains the first housing (20A) and the second housing (20B) the connector (10) at the open position (OP).

9. A method of assembling a connector (10), comprising the following steps:
providing the connector (10) according to claim 1;
positioning the first housing (20A) and the second housing (20B) of the connector (10) at the open position (OP);
at least partly accommodating one or more first terminal fittings (80A) into the one or more respective first cavities (23A);
at least partly accommodating one or more second terminal fittings (80B) into the one or more respective second cavities (23B); and
transitioning the first housing (20A) and the second housing (20B) of the connector (10) to the closed position (CP).

10. The method according to claim 9, further comprising crimping the terminal fittings (80A; 80B) to a cable (90) in order to mechanically and/or electrically connect them with each other while the first housing (20A) and the second housing (20B) of the connector (10) are positioned at the open position (OP).
